(19) United States
(12) Patent Application Publication
(10) Pub. No.: US 2011/0038390 A1
(43) Pub. Date: Feb. 17, 2011

(54) MULTI-PLATE COMPOSITE VOLUME BRAGG GRATINGS, SYSTEMS AND METHODS OF USE THEREOF

(75) Inventors: James V. RUDD, Louisville, CO (US); Edward J. MIESAK, Windermere, FL (US)

Correspondence Address: BIRCH STEWART KOLASCH & BIRCH, PO BOX 747, FALLS CHURCH, VA, 22040-0747, US

(73) Assignee: Lockheed Martin Corporation, Bethesda, MD (US)

(21) Appl. No.: 12/846,606

(22) Filed: Jul. 29, 2010

Related U.S. Application Data
(60) Provisional application No. 61/229,692, filed on Jul. 29, 2009.

(51) Int. Cl. H01S 3/10; G02B 27/44

(52) U.S. Cl. 372/25; 359/576

(57) ABSTRACT

Variations of composite volume Bragg grating devices and methods for creating same are disclosed. Also, variations of chirped pulse amplification laser systems, and system portions, that make use of a composite volume Bragg grating device for pulse stretching and/or compression are disclosed.

### PRIORITY

The present invention claims benefit of priority to Provisional Application 61/229,692, filed in the U.S. Patent and Trademark Office on Jul. 29, 2009, the entire contents of which are hereby incorporated by reference.

### FIELD OF THE INVENTION

The present invention generally relates to chirped pulse amplification and, in particular, relates to multi-plate Volume Bragg Grating (VBG) systems and methods for chirped pulse amplification

### BACKGROUND OF THE INVENTION

Chirped pulse amplification is a technique for making energetic femtosecond laser pulses. In this technique, the peak power is reduced by stretching the pulse in time, then the pulse is amplified, and finally the original pulse width is restored through compression. Stretching/compression ratios may be as high as 5000, stretching a 50 femtosecond pulse to more than 2 nanoseconds for amplification. One difficulty in chirped pulse amplification techniques is the size of pulse stretchers and compressors.

As can be seen in FIG. 1, in typical high-power (greater than 10 millijoules per pulse) chirped-pulse amplification (CPA) laser systems, stretcher 111 and compressor components 101 typically take up a large portion of the system size. CPA systems are also difficult to properly align and do not remain aligned outside of lab environments, making them generally unsuitable for practical applications.

Volume Bragg Gratings (VBG) can act as stretchers and compressors, but they have lower pulse energy handing capability, cannot efficiently handle bandwidths greater than 5 nanometers, cannot be made with a dispersion parameter greater than 50 picoseconds per nanometer, and are prone to damage resulting from manufacturing and/or contamination defects on and in the structure of the VBG. Present state of the art VBG stretchers and compressors have only produced pulses with energy less than one millijoule. Their low damage threshold requires large diameter beams, but present VBG technology limits apertures to less than 10 millimeters, thus setting an upper limit on the pulse energy and average power that can be compressed after amplification.

It would therefore a significant advance in the art to provide a VBG system capable of handling high power levels, wide bandwidths, and nanosecond-level compression. It would be a further advance to make such a VBG system small and robust to allow for effective and efficient implementation outside of lab environments.

### SUMMARY OF THE INVENTION

In accordance with one aspect of the subject disclosure, a multi-plate volume Bragg grating (VBG) system is provided. Each VBG element may reflect and stretch a portion of an overall pulse, but may do so with high efficiency. In one variation of a multi-plate VBG system, increasing the overall VBG cross-sectional area results in an increase in the overall power that the VBG array can withstand. Moreover, multiple VBGs with similar dispersion parameters can be tiled and optically bonded to increase the VBG cross-sectional area creating a composite VBG. In a particular variation, 4 VBGs having identical dispersion parameters may be used to build the composite VBG. By arranging multiple composite VBG devices in the proper order, large stretch factors with wide bandwidth and high power can be achieved. Using the same multi-plate VBG for both stretching and compressing facilitates the canceling-out of localized distortions that may occur during the stretching (caused by the different separation of the individual VBG plates) by performing compression in the same VBG plate.

Another aspect of the subject disclosure pertains to the ruggedization and portability of laser systems having a single stretcher/compressor component. Utilizing one or more VBG elements as both a beam stretcher and a beam compressor reduces issues associated with both system size and optical alignment because the issue of aligning the beam stretcher with the beam compressor is eliminated. Furthermore, portability and usability of such a system is improved because the single compressor/stretcher configuration reduces vibration sensitivity and removes the need for significant re-alignment after moving or re-arranging the system.

Some variations of laser systems using a composite VBG for beam stretching and compression may be packaged into portable or vehicle-mounted units. Such units may have appropriate shock-absorbing, vibration-dampening, or other ruggedization and alignment preservation features for related optical components such as beam entry and exit telescopes, mirrors, pre-stretchers, post-compressors, and amplifier assemblies.

Yet another aspect of the subject disclosure deals with beam alignment for compression, relating to issues for compensation of localized distortions introduced during beam stretching. Because a VBG or composite VBG element will invariably contain certain minor defects or variations as a result of the manufacturing process, a stretched beam will contain certain localized distortions as a result of those defects and variations. In order to remove those localized distortions during beam compression, the stretched beam must be aligned such that it enters the VBG for compression in exactly the same manner and alignment that it exited the VBG after stretching. In other words, it is preferred that the beam entering VBG from one side for stretching have the same beam diameter, collimation and orientation as the beam entering the VBG from other side for compression such that the beam encounters the same 3 dimensional defect structure during stretching as it does during compression. Such alignment issues may be resolved with arrangements of optical elements such as mirrors, lenses, and telescopes. In one variation, a telescope on the stretcher side and a telescope on the compressor side of the beam path are the same (preferably identical) so that the beam perturbations caused by the 3 dimensional defect structures cancel out.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF DRAWINGS

The present invention will become more fully understood from the detailed description given herein below and the accompanying drawings which are given by way of illustration only, and thus are not limitative of the present invention, and wherein

FIG. 1a depicts a prior art CPA laser system;

FIG. 1b depicts an embodiment of a multi-plate VBG stretcher/compressor;

FIG. 2a depicts an embodiment of a multi-plate VBG stretcher/compressor made up of composite VBGs;

FIG. 2b depicts an embodiment of a composite VBG;

FIG. 3 depicts a block diagram of an embodiment of a CPA system with a composite VBG as described herein;

FIG. 4a depicts a functional block diagram of a compression and stretching sequence in a CPA system as described herein;

FIG. 4b depicts a block diagram of a compressor/stretcher configured for localized-distortion compensation;

FIG. 5a depicts a variation of a CPA system with composite VBG elements in a cascade configuration;

FIG. 5b depicts a variation of a CPA system with composite VBG elements in a series configuration; and

FIG. 5c depicts a variation of a CPA system with a long composite VBG element.

The drawings will be described in detail in the course of the detailed description of the invention.

### DETAILED DESCRIPTION OF THE INVENTION

The following detailed description of the invention refers to the accompanying drawings. The same reference numbers in different drawings identify the same or similar elements. Also, the following detailed description does not limit the invention. Instead, the scope of the invention is defined by the appended claims and equivalents thereof.

Some chirped-pulse amplification (CPA) systems stretch and compress pulses using separate optical systems. For example using a grating-based stretcher and another grating based compressor. Volume-Bragg gratings (VBGs) are capable of acting as both a stretcher and compressor and may be used in CPA systems. For example, using a VBG, pulses may be stretched from 300 femtoseconds (fs) out to 100 picoseconds (ps), and then back to 1.1 ps. The power efficiency of such a VBG system is around 70% and the bandwidth of the grating is only 5 nm wide.

Stretching and compressing ultra short (e.g., <1 ps) pulses presents a challenge. One approach to doing so involves using a system relying upon material or spatial dispersion to stretch the pulse (the stretcher), and a separate dispersive system with the opposite sign of dispersion to compress the pulse back down to its original length (the compressor). A number of approaches using two separate systems may be used to stretch and compress pulses. These devices are often very large and require very precise alignment in order to work. They are therefore impractical for applications outside of a strictly controlled lab setting because a misalignment, especially in a high-energy system, can lead to undesirable pulse broadening and even catastrophic failure.

Furthermore, even the most compact stretcher/compressor designs, such as those used in down-chirp pulse amplification, can only be used for pulses up to a millijoule (mJ) of energy. This is because compact designs tend to be fragile and unable to withstand high energy levels.

VBG-based stretchers and compressors can be used to create compact, high-power CPA systems, but there are a number of limitations to using a VBG-based system that must be overcome to make them practical and feasible for field applications and high-power applications. To amplify a short optical pulse, large bandwidths need to be stretched and compressed efficiently. VBG technology inherently becomes less efficient as the bandwidth is increased. As power requirements increase, stretch ratios required to affect the necessary amplification increase accordingly. Finally, the input/output aperture of a VBG must be large enough to handle the fluence of a higher power pulse. Large apertures are more easily realized by using a thinner VBG that has a narrower bandwidth.

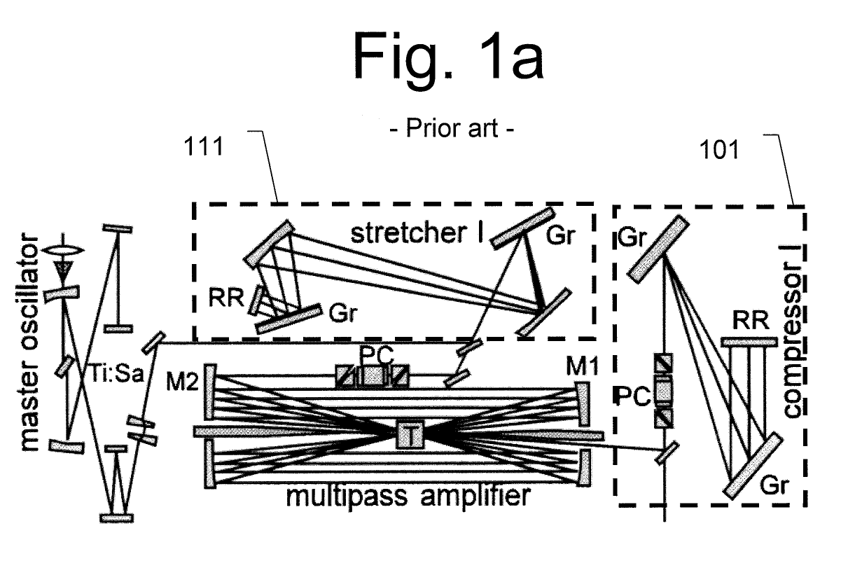

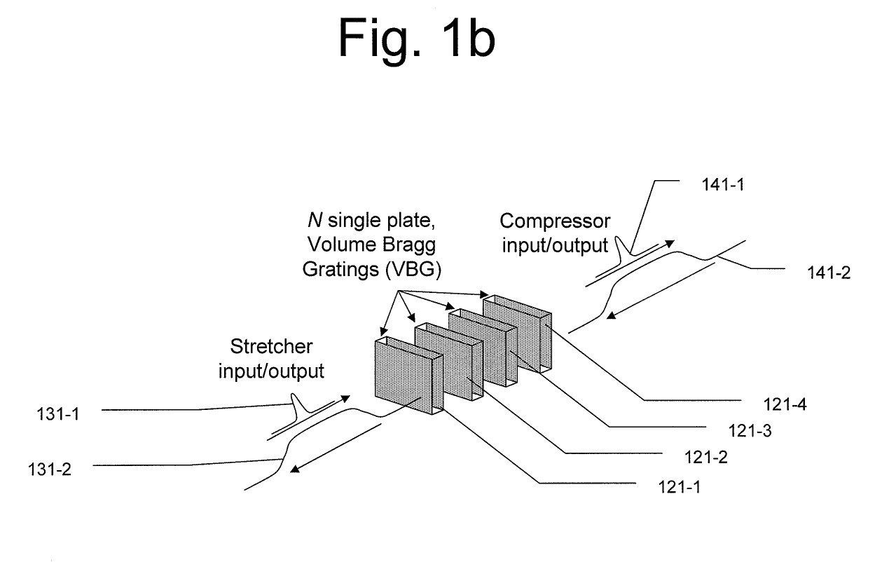

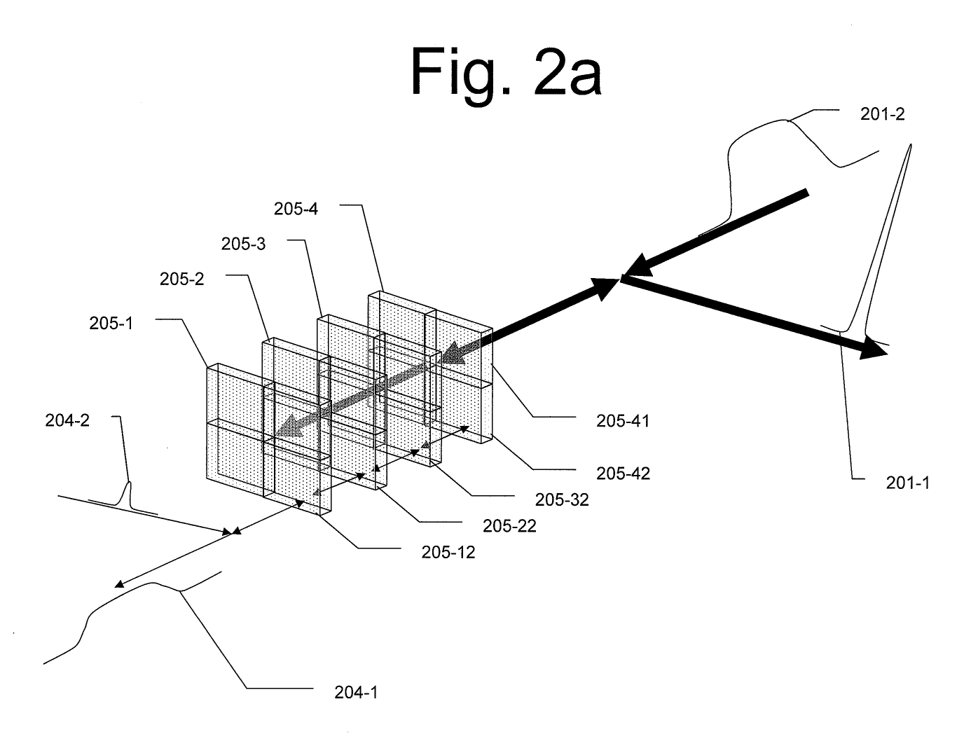

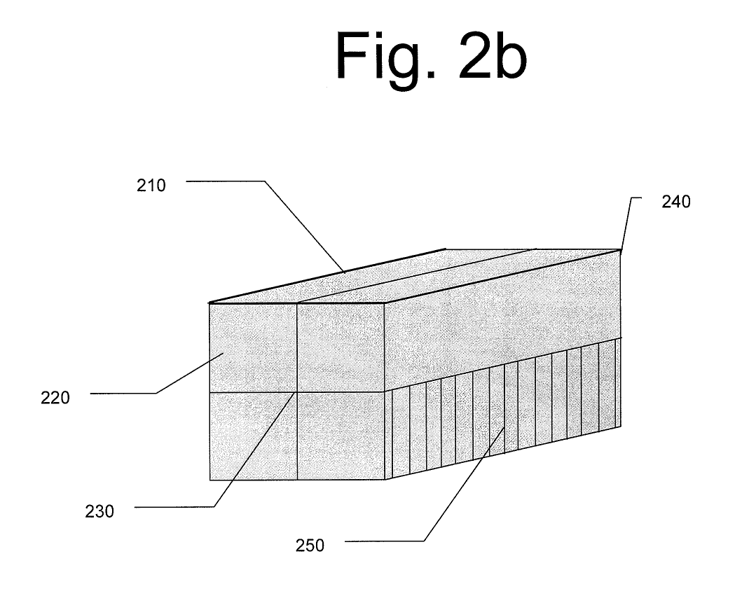

An example of a multi-plate VBG stretcher-compressor system using the invention is depicted in FIG. 1b. In the example shown, the multi-plate VBG has four gratings 121-1, 121-2, 121-3, 121-4 each having the same bandwidth, but each with a different center wavelength arranged to provide a bandwidth four times wider than for an individual VBG. Variations of a VBG may have as many gratings as cost, space, and power requirements may permit. Using the multi-plate VBG as a stretcher, a narrow pulse 131-1 is transmitted into a face of the first VBG and individual gratings return a portion of the input pulse such that the overall output is a longer, multi-spectral pulse 131-2 made up of the returned pulse portions. Using the multi-plate VBG as a compressor, a long, multi-spectral pulse 141-2 is input into an opposite face of the fourth VBG and individual gratings return portions of the input pulse such that all the portions exit the VBG at the same time to produce a shorter, higher-power pulse 141-1. In one example of a VBG stretcher/compressor, a multi-plate VBG having N gratings each with a reflection band of approximately 2 nanometers and a dispersion value of 50 picoseconds per nanometer will stretch an input pulse having a bandwidth of 2*N nanometers to N*100 picoseconds. Issues associated with damage and diffraction efficiency arises, however, as the power of the pulse or the required stretching or compression level increases. Input pulses requiring stretching or compression in excess of 100 picoseconds call for large/long VBGs, which inherently have poor diffraction efficiency. By using multiple, smaller/shorter VBG in a series arrangement as shown in FIG. 1b, the poor efficiency can be overcome. Furthermore, trying to compress output pulses to levels of even a tenth of a joule-per-pulse can cause catastrophic damage to a typical VBG. Using a composite VBG such as shown in FIG. 2b increases the cross-sectional area of a VBG thus allowing for compression of higher energy pulses. Combining these two techniques into a multi-plate series of composite VBGs as shown in FIG. 2a allows for large stretching/compression ratios and the ability to handle large pulse energies.

Part of the energy-level limitation of a VBG is due to a combination of pulse intensity and VBG cross-sectional area. Due the fragility of a VBG, fluence needs to be less than one joule per square centimeter, which requires a comparatively large diameter beam. For example, to amplify a 10 nanojoule, 100 femtosecond pulse to a one-joule, sub-picosecond pulse, a beam 11 millimeter or more in diameter may be required to avoid damaging a VBG. To increase the power levels a VBG can accommodate, a composite VBG with a larger overall face/aperture may be used. A composite VBG may be created by fusing one or more VBGs together and passing pulse portions through a sector of the composite VBG to create an overall stretching/compression effect on the entire pulse. An example of a composite VBG is illustrated in FIG. 2b.

In the example shown in FIG. 2a, a multi-plate VBG having four composite gratings 205-1, 205-2, 205-3, 205-4, with each composite grating composed of four panels. Each panel in a grating 205-41, 205-42 represents a grating in a composite VBG array, with the VBG arrays being bonded together or otherwise assembled into a larger multi-plate composite array. Each VBG grating panel 205-41 may therefore only receive a portion of an incoming pulse, reducing the fluence exerted on it to non-damaging levels. Because this device is comprised of multi-plate VBGs where each VBG is a composite VBG, the device may also be referred to as a multi-plate composite VBG.

In a variation where the multi-plate composite VBG array acts as a stretcher, an incoming pulse 204-2 may be a small-diameter beam, small enough to fit within a VBG panel 205-42. A 100 femtosecond pulse having approximately 10 nanojoules of energy may thereby be stretched, in a VBG having N gratings of approximately 1 nanometer each, to an output pulse 204-1 of N*100 picoseconds.

In a variation where the multi-plate composite VBG array acts as a compressor, an incoming pulse 201-2 of approximately 1 joule, having a duration of N*100 pico-seconds, enters the VBG array as a large-diameter beam 202 that may impinge upon all of the panels of each composite VBG. that comprises the multi-plate composite VBG array. A portion of the pulse is compressed through a sequence of grating panels 205-42, 205-32, 205-22, 205-12. Each beam portion is so compressed by each sequence of panels, causing the multi-plate composite VBG array to return an overall pulse 201-1 less than 0.1 pico-seconds in duration and having a peak-power in excess of a terawatt.

Alternate variations may use different pulse intensities and durations, different grating sizes in the VBG, different beam widths, and different composite VBG arrangements (such as a 2-panel composite). Suitable variations of a composite VBG may be created using VBGs with the same dispersion parameters that are tiled and optically bonded. By stacking these devices in the proper order, large stretch factors with wide bandwidths and high powers can be achieved. Furthermore, in variations where the same composite VBG is used for both stretching and compressing, localized distortions that may occur during the stretching (potentially caused by the different separation of the individual VBG plates and/or material defects within the VBG plates themselves) will be undone during compression. An example of a composite VBG suitable for stretching and compression is depicted in FIG. 2b.

In the variation shown, the composite VBG 210 is made of four individual VBGs that are bonded together. The stretcher input/output face 220 and the compressor input/output face 240 are on opposite ends of the composite VBG 210. Bond lines 230 may exist where the individual VBGs are bonded together, and the gratings within each VBG 250 are perpendicular to the optical direction of travel. The grating lines shown 250 represent planes on which an index of refraction has been changed to generate the grating. Although only one VBG in the composite is depicted as having gratings lines, they are present in every VBG.

Variations of a VBG may be made of photo-thermal refractive glasses, plastics or polymers with appropriate thermal properties. Variations of a composite VBG may be made of two or more substantially similar VBGs bonded together such that the bond lines/bond regions do not interfere with the optical transmission paths within each VBG element. Variations of a composite VBG device may be assembled from two, four, or more individual VBG elements. Some variations may be made of 25 or more individual VBG elements. Yet further variations may create a composite VBG by bonding individual or composite VBG elements end-to-end, thereby extending the effective length of the CVBG to provide a greater range of pulse stretching and/or compression.

When compared to other stretcher/compressor systems a composite VBG has a smaller volume and a simpler alignment. The ability to build a ruggedized, high-power CPA system is greatly enhanced by using such a device. In accordance with one aspect of the subject disclosure, a stretcher/compressor system (the dispersion system) using composite VBG may have a volume as much as 10× smaller than other approaches, while retaining the ability to handle the same power and produce the same output pulse width as competing technologies. Also, a composite VBG system can be configured such that does not need adjustments, whereas present state-of-the-art requires one to choose between compact systems with low energy and broad pulses, or bulky systems with high-energy, short pulses, and many adjustments.

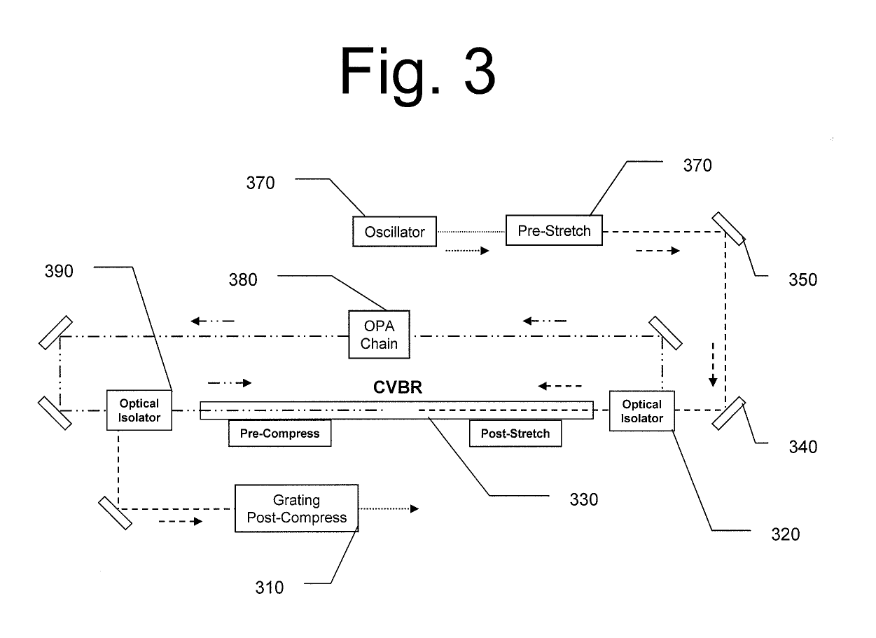

Variations of a system using a composite VBG for pulse stretching and compression may also eliminate beam alignment, vibration sensitivity, and contamination concerns by being enclosed in a sealed, shock-absorbing container. An example of a CPA system with a composite VBG stretcher/compressor is depicted in FIG. 3.

It is to be understood that conventional techniques may be used for separating incoming and outgoing pulses that impinge upon a grating. Such techniques can also be applied to the multi-plate VBG and/or composite multi-plate VBG inventions recited herein and are particularly useful when used in a system like a CPA. One such conventional technique includes adding polarizers to the incident beam paths. For example, a linear polarizer (not shown) may be inserted before the VBG 205-1 and another linear polarizer (not shown) may be inserted after the composite VBG 205-4. As is well known, such polarizers act to separate the incoming and outgoing pulses when used in conjunction with a combination of other polarization-altering optics such as a Faraday rotator, a quarter waveplate, a half waveplate, or some combination of all of these. Other such known techniques may be utilized for such beam separation in the conventional fashion.

In the example shown, a CPA system begins with an oscillator 360 that outputs a pulse into a pre-stretch 370 that stretches the pulse around a predetermined central wavelength. The pre-stretched pulse is then transmitted to an optical isolator 320. The transmission path may involve mirrors 350, 340 as depicted, or may involve other variations such as fiber-optics, more or fewer mirrors, prisms, or other suitable optical elements. The optical isolator 230 is used to prevent feedback from the composite VBG 330 to the pre-stretch. The after being further stretched in the composite VBG 330, the pulse then passes through the optical isolator 320 and into an optical parametric amplifier chain 380 before entering the compression side of the composite VBG 330 through another optical isolator 390. The compressed beam then goes through a post-compressor 310 before finally being output. Variations of a pre-stretch 370 may include a GRISM or some other form of optical stretcher to extend a pulse prior to the CVBG stretching/amplification/CVBG compression process. Variations of the system shown in FIG. 3 may also exclude the use of the pre-stretch and grating-post-compress components altogether, relying solely on the stretching and compression afforded by the CVBG. Variations of the optical isolators 320, 390 may include faraday isolators, rotary isolators, polarization-independent isolators, and/or other known optical isolator types. In some further variations, an optical isolator assembly may include a telescope or other optical assembly injects the beam into the VBG with a desired beam diameter, collimation and alignment. In one variation, the telescope in the stretcher-side optical isolator assembly 320 is the same as the telescope in the compressor-side optical isolator assembly 390. In other variations, a telescope may be included as part of, or used in place of or in addition to one or more of the mirrors 350, 340 in the beam path.

In some variations, a system of the type discussed above may be placed in a portable or vehicle-mounted enclosure that is sealed against dust, moisture, and other environmental contaminants. Such an enclosure may include shock-absorbing components or assemblies to keep telescopes, mirrors, and other components properly aligned. In some variations, an entire system may be encased in foam or molded materials such that only the beam-paths between components are open space within the enclosure. In other variations, an enclosure might include gyroscopic elements that preserve the alignment of individual system components regardless of orientation or dislocation of the assembly.

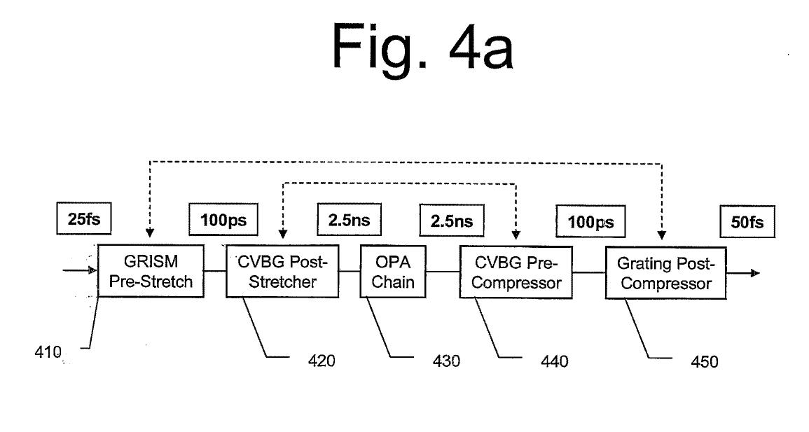

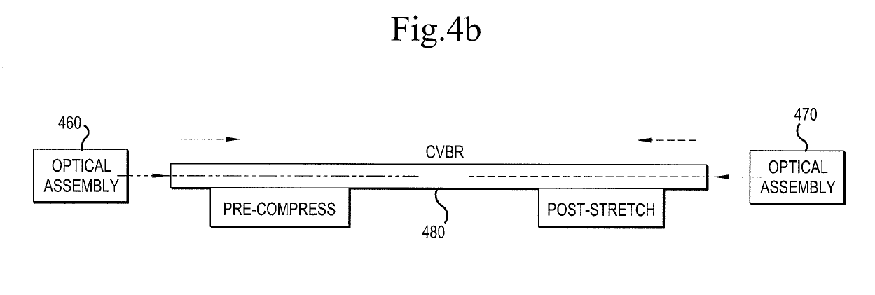

An example of the relative pulse stretching/compression that can be accomplished by a variation of the system shown in FIG. 3 is depicted in FIG. 4a. In the example shown, a 25 femto-second pulse entering the pre-stretch 410 is expanded to 100 pico-seconds and then further stretched to 2.5 nano-seconds in the composite VBG stretcher 420. This 2.5 nano-second pulse is then passed into the optical parametric amplifier (OPA) chain 420 and then compressed by passing through the compression-side of the composite VBG 440, resulting in a 100 pico-second pulse. This compressed pulse then goes through a multi-bounce grating post-compressor 450 to produce a 50 femto-second output pulse. Actual power amplification happens in the OPA chain 430 after the beam is stretched. This allows the realization of many orders of magnitude of amplification on a compressed signal by relatively low levels of amplification applied to a stretched signal.

In variations of a system using one or more common VBG elements as both stretchers and compressors, mitigation and compensation for localized beam distortions may be a concern. Because minor defects and variations may arise in the fabrication, construction, and assembly of VBG and composite VBG elements and VBG arrays, a stretched beam may, in the course of stretching, become subject to certain localized distortions or non-distributed imperfections as a result of the three-dimensional nature of any defects and irregularities. Such localized distortions can be mitigated most effectively by passing the stretched beam through the compressor side of the VBG at the same alignment, beam diameter and collimation as that output from the stretcher-side.

A variation of such a compensation approach is depicted in FIG. 4b. In the variation shown, an optical assembly 470 in the stretcher-side beam path and an optical assembly in the compressor-side beam path 460 of the VBG element 480 are the same. This ensures that the beam exiting the stretcher aspect of the VBG has the same diameter, collimation and alignment as the beam that will be fed into the compressor side. In such an approach, localized distortions introduced into the beam by the VBG element are subsequently removed or cancelled out by passing the stretched beam through the same regions of the VBG element during beam compression.

The variation shown in FIG. 4b uses a telescope as the optical assembly. As shown therein, the telescopes are disposed on either side of a single composite VBG element, however other variations may include optical assemblies arranged around arrays of VBG elements, or multiple VBG elements each with their own set of optical assemblies. Although depicted as immediately adjacent to the VBG element, the optical assemblies may be positioned anywhere in the beam path so long as the beam is imparted with the proper diameter, collimation and alignment after stretching and prior to compression.

In the variation depicted, the optical assemblies are telescopes. In other variations, any suitable assembly or arrangement of lenses, prisms, mirrors and/or other refractive and reflective elements may be used to impart a desired diameter, collimation, and alignment to a beam or pulse entering a composite VBG.

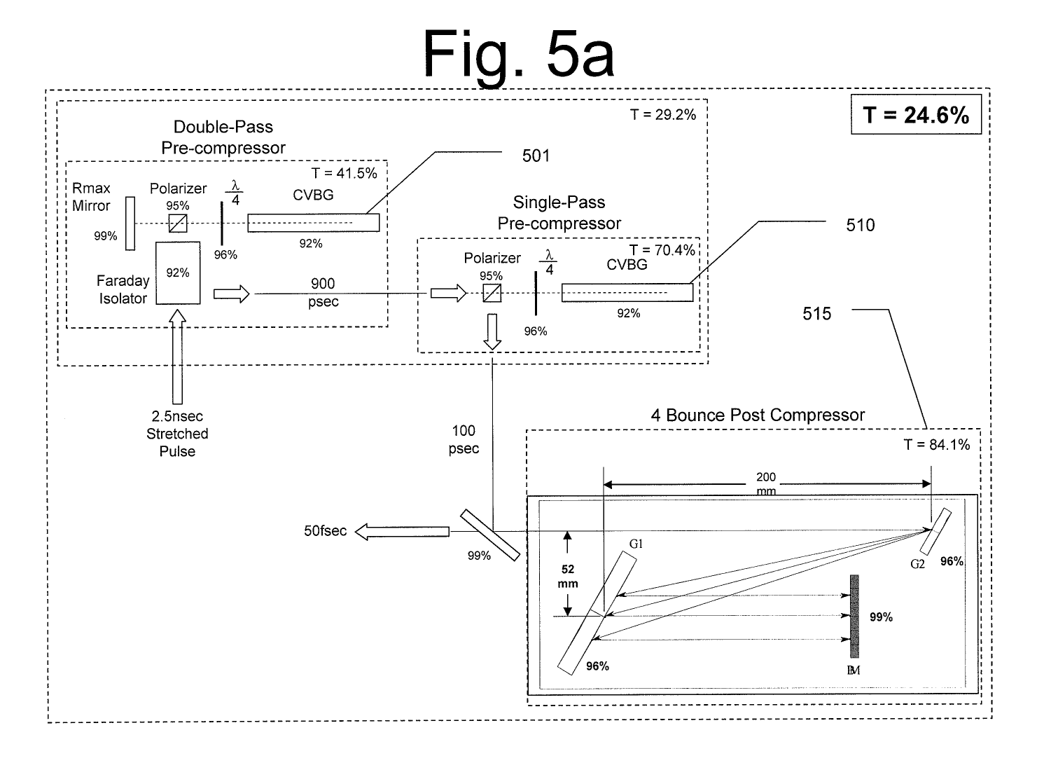

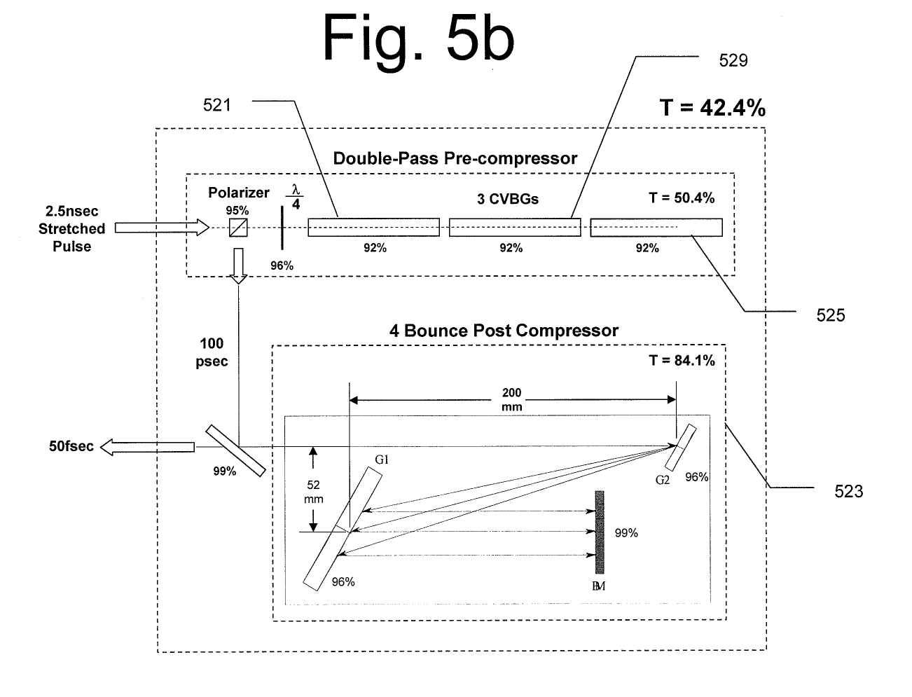

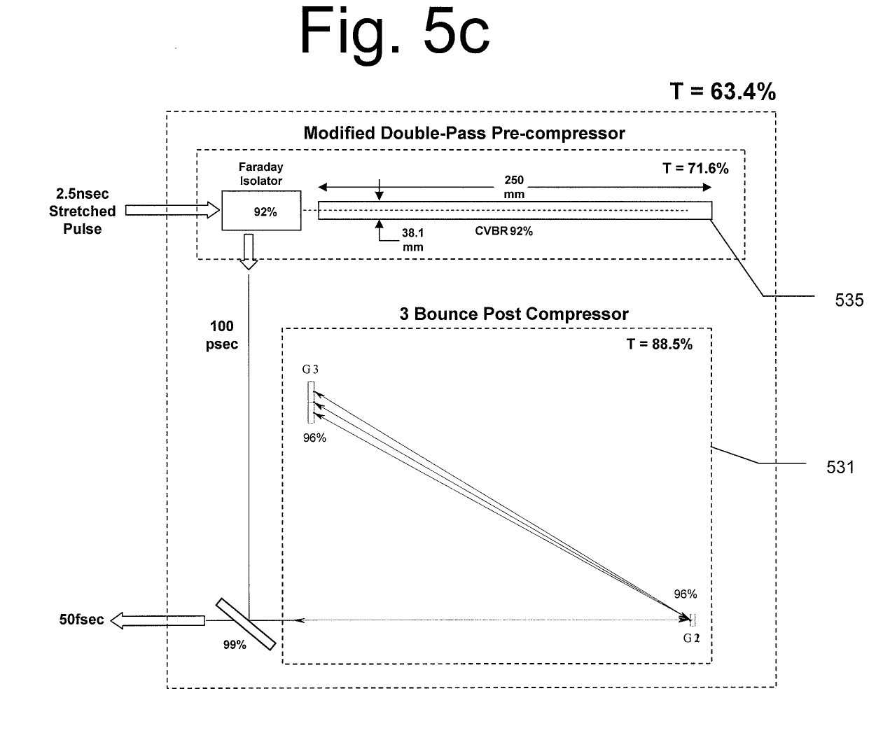

Variations of a CPA system according to this description may also include systems having multiple composite VBG elements and/or composite VBG elements of varying size and length. One variation may include two or more cascaded composite VBG elements. One such variation is depicted in FIG. 5a. The composite VBG (CVBG) elements in a cascade arrangement 501, 510 may have the same dimensions or different dimensions depending on the application and requirements of the system. In other variations, there may also be additional CVBG elements in the cascade. In the variation depicted, the CVBG elements 501, 510 both have a length of 83 mm. The post-compressor 515 depicted is a four bounce post-compressor. Further variations may include various post-compressor configurations, including two-bounce, three-bounce, four-bounce or others.

Another CPA system variation may include two or more composite VBG elements in series. Such a variation is depicted in FIG. 5b. The CVBG elements in series 521, 529, 525 may have the same dimensions or different dimensions depending on the application and requirements of the system. In other variations, there may also be more or fewer CVBG elements in the series. In the variation depicted, the CVBG elements 521, 529, 525 all have a length of 83 mm. In the variation depicted, the post-compressor 523 is a four bounce post-compressor. Further variations may include various post-compressor configurations, including two-bounce, three-bounce, four-bounce or others.

Yet further variations may include one long composite VBG element. Such a variation is depicted in FIG. 5c. The CVBG element 535 may have dimensions based on the application and requirements of the system. In some variations, the CVBG element may be built from many individual VBG elements. The variation shown has a CVBG 535 made of twenty five individual VBG elements, each having a 7.62 mm×7.62 mm face and a 250 mm length. Other variations of a CVBG may have more or fewer VBG elements of different dimensions. Some variations may also accomplish a large overall length by connecting individual VBG elements end-to-end as well as, or instead of, side-by-side.

Variations of CVBG elements may vary in length from 70 mm to 300 mm depending on the arrangement, application, efficiency, and size requirements of the CPA system. Further variations may also include various post-compressor configurations, including two-bounce, three-bounce, four-bounce or others.

Variations of a CPA system according to this description may use commercially available, modified, or custom-built oscillators, grism devices, mirrors, faraday isolators, and OPA components. Variations of an OPA chain in a CPA system according to this description may have multiple stages depending on the level and type of amplification required and the intended system application and operating environment.

The description of the invention is provided to enable any person skilled in the art to practice the various embodiments described herein. While the present invention has been particularly described with reference to the various figures and embodiments, it should be understood that these are for illustration purposes only and should not be taken as limiting the scope of the invention.

There may be many other ways to implement the invention. Various functions and elements described herein may be partitioned differently from those shown without departing from the spirit and scope of the invention. Various modifications to these embodiments will be readily apparent to those skilled in the art, and generic principles defined herein may be applied to other embodiments. Thus, many changes and modifications may be made to the invention, by one having ordinary skill in the art, without departing from the spirit and scope of the invention.

A reference to an element in the singular is not intended to mean “one and only one” unless specifically stated, but rather “one or more.” The term “some” refers to one or more. Underlined and/or italicized headings and subheadings are used for convenience only, do not limit the invention, and are not referred to in connection with the interpretation of the description of the invention. All structural and functional equivalents to the elements of the various embodiments described throughout this disclosure that are known or later come to be known to those of ordinary skill in the art are expressly incorporated herein by reference and intended to be encompassed by the invention. Moreover, nothing disclosed herein is intended to be dedicated to the public regardless of whether such disclosure is explicitly recited in the above description.

The invention being thus described, it will be obvious that the same may be varied in many ways. Such variations are not to be regarded as departure from the spirit and scope of the invention, and all such modifications as would be obvious to one skilled in the art are intended to be included within the scope of the following claims.

1. A composite volume Bragg grating (VBG) device, the device comprising:
a first VBG device having a specified face area, a specified length and a specified number of gratings, each grating having a specified width; and
a second VBG device having the specified face area, the specified length and the specified number of gratings, each grating having the specified width;
where the first VBG device and second VBG device are bonded together to create a composite VBG device having the specified length and a face area based on the combined face areas of the first and second VBG devices; and
the individual VBG devices are bonded together such that the composite VBG device performs optical stretching along a first optical travel direction and optical compression along a second optical travel direction through the composite VBG device;
such that a first portion of an incoming optical pulse passes through the first VBG, a second portion of an incoming optical pulse passes through the second VBG and the first and second portions exit the composite VBG together as an outgoing stretched or compressed optical pulse.

2. The composite VBG device of claim 1, the device further comprising:
a third VBG device and a fourth VBG device, the third and fourth VBG devices each having the specified length, the specified face area, and the specified number of gratings, each grating having the specified width;
where the third and fourth VBG devices are bonded to the first and second VBG devices to create a composite VBG device having the specified length and a face area based on the combined face areas of the first, second, third, and fourth VBG devices;
such that a third portion of an incoming optical pulse passes through the third VBG, a fourth portion of an incoming optical pulse passes through the second VBG, and the third and fourth portions exit the composite VBG together with the first and second portions as an outgoing stretched or compressed optical pulse.

3. The composite VBG of claim 1, the device further including a first and a second optical assembly, the first optical assembly being positioned at a stretcher end of the composite VBG device, the second optical assembly being positioned at a compressor end of the composite VBG device, and where the first and second optical assemblies are configured such that the second optical assembly adjusts the beam going into the compressor end so that it has a diameter, collimation and rotational alignment similar to that of the beam output from the stretcher end.

4. The composite VBG of claim 1, where the bonding does not negatively affect the operation of the individual VBG devices in the composite VBG device.

5. The composite VBG of claim 1, where the specified length is between 80 and 400 millimeters.

6. The composite VBG of claim 1, where the specified face area is between 620 and 23,000 square millimeters.

7. The composite VBG of claim 1, the device further including a pre-stretch component that stretches the optical pulse before it enters the composite VBG for stretching.

8. A method of making a composite volume Bragg grating (VBG) device, the method comprising:
providing a first VBG device having a specified face area, a specified length and a specified number of gratings, each grating having a specified width;
providing a second VBG device having the specified face area, the specified length and the specified number of gratings, each grating having the specified width; and
creating a composite VBG device having the specified length and a face area based on the combined face areas of the first and second VBG devices by bonding the first VBG device and second VBG device together;
where bonding is performed such that
the composite VBG device performs optical stretching along a first optical travel direction and optical compression along a second optical travel direction through the composite VBG device; and
a first portion of an incoming optical pulse passes through the first VBG, a second portion of an incoming optical pulse passes through the second VBG, and the first and second portions exit the composite VBG together as an outgoing stretched or compressed optical pulse.

9. The method of claim 8, the method further comprising:
providing a third VBG device and a fourth VBG device, the third and fourth VBG devices each having the specified length, the specified face area, and the specified number of gratings, each grating having the specified width; and
creating a composite VBG device having the specified length and a face area based on the combined face areas of the first, second, third, and fourth VBG devices by bonding the third and fourth VBG devices to the first and second VBG devices;
such that a third portion of an incoming optical pulse passes through the third VBG, a fourth portion of an incoming optical pulse passes through the second VBG, and the third and fourth portions exit the composite VBG together with the first and second portions as an outgoing stretched or compressed optical pulse

10. A chirped pulse amplification (CPA) laser system having a composite volume Bragg grating (VBG) device, the system comprising:
an oscillator generating an initial optical pulse;
a pre-stretcher device performing an initial stretch on the initial pulse, resulting in an initially stretched pulse;
a first optical isolator preventing optical feedback between the pre-stretcher, the composite VBG, and an optical parametric amplifier (OPA) arrangement; and
a second optical isolator preventing optical feedback between the OPA arrangement, the composite VBG, and a post-compressor;
where
the composite VBG disposed such that the initially stretched, first isolated pulse is further stretched in the composite VBG;
the OPA arrangement disposed such that the further stretched pulse is amplified in the OPA arrangement;
the composite VBG further disposed such that the OPA amplified, second isolated pulse is compressed in the composite VBG; and
the post-compressor is disposed such that the VBG-compressed pulse is further compressed in the post-compressor; and
further where the composite VBG includes
a first VBG device having a specified face area, a specified length and a specified number of gratings, each grating having a specified width; and
a second VBG device having the specified face area, the specified length and the specified number of gratings, each grating having the specified width;
where the first VBG device and second VBG device are bonded together to create a composite VBG device having the specified length and a face area based on the combined face areas of the first and second VBG devices; and
the individual VBG devices are bonded together such the composite VBG device performs optical stretching along a first optical travel direction and optical compression along a second optical travel direction through the composite VBG device;
such that a first portion of an incoming optical pulse passes through the first VBG, a second portion of an incoming optical pulse passes through the second VBG, and the first and second portions exit the composite VBG together as an outgoing stretched or compressed optical pulse.

11. The CPA laser system of claim 10, where
the composite VBG device further includes a second composite VBG device arranged in a cascade with the composite VBG device; and
where the composite VBG device and the second composite VBG device have the same properties and dimensions.

12. The CPA laser system of claim 10, where
the composite VBG device further includes a second composite VBG device arranged in series with the composite VBG device; and
where the composite VBG device and the second composite VBG device have the same properties and dimensions.

13. The CPA laser system of claim 10, where the post-compressor is a four-bounce post-compressor.

14. The CPA laser system of claim 10, where the composite VBG device further includes:
a third VBG device and a fourth VBG device, the third and fourth VBG devices each having the specified length, the specified face area, and the specified number of gratings, each grating having the specified width;
where the third and fourth VBG devices are bonded to the first and second VBG devices to create a composite VBG device having the specified length and a face area based on the combined face areas of the first, second, third, and fourth VBG devices;
such that a third portion of an incoming optical pulse passes through the third VBG, a fourth portion of an incoming optical pulse passes through the second VBG, and the third and fourth portions exit the composite VBG together with the first and second portions as an outgoing stretched or compressed optical pulse.

15. The CPA laser system of claim 10, where the first and second optical isolators are faraday isolators.

16. The CPA laser system of claim 10, where the pre-stretcher is a grism.

17. The CPA laser system of claim 10, the system further including a first and a second beam alignment telescope, the first telescope being positioned at a stretcher side of a beam path into the composite VBG device, the second telescope being positioned at a compressor side of a beam path into the composite VBG device, and where the first and second telescopes are configured such that the second telescope adjusts the beam going into the compressor side so that it had a diameter, collimation and rotational alignment similar to that of the beam output from the stretcher side.

18. An optical pulse stretcher and compressor device in a pulsed laser system, the device comprising:
a first composite volume Bragg grating (VBG) including
a first VBG device having a specified face area, a specified length and a specified number of gratings, each grating having a specified width; and
a second VBG device having the specified face area, the specified length and the specified number of gratings, each grating having the specified width;
where the first VBG device and second VBG device are bonded together to create a composite VBG device having the specified length and a face area based on the combined face areas of the first and second VBG devices; and
where the individual VBG devices are bonded together such the composite VBG device performs optical stretching along a first optical travel direction and optical compression along a second optical travel direction through the composite VBG device;
such that a first portion of an incoming optical pulse passes through the first VBG, a second portion of an incoming optical pulse passes through the second VBG, and the first and second portions exit the composite VBG together as an outgoing stretched or compressed optical pulse.

19. The optical pulse stretcher and compressor device of claim 18, the device further comprising a second composite VBG having the same properties as the first VBG and arranged in an optical cascade with the first VBG.

20. The optical pulse stretcher and compressor device of claim 18, the device further comprising a second composite VBG having the same properties as the first VBG and arranged in an optical series with the first VBG.

21. The optical pulse stretcher and compressor device of claim 18, the device further comprising a second composite VBG having different properties than the first VBG and arranged in an optical series with the first VBG.

22. The optical pulse stretcher and compressor device of claim 18, the device further comprising a grating post-compressor and a polarizer arranged to pass a compressed pulse exiting the composite VBG to the grating post-compressor.

23. The optical pulse stretcher and compressor device of claim 22, the grating post-compressor comprising a four-bounce post-compressor.

24. The optical pulse stretcher and compressor device of claim 18, where the bonding does not negatively affect the operation of the individual VBG devices in the composite VBG device.

25. A method of compensating for localized beam distortions in a composite volume Bragg grating (VBG) device, the method comprising:
providing a first VBG device having a specified face area, a specified length and a specified number of gratings, each grating having a specified width;
providing a second VBG device having the specified face area, the specified length and the specified number of gratings, each grating having the specified width; and
creating a composite VBG device having the specified length and a face area based on the combined face areas of the first and second VBG devices by bonding the first VBG device and second VBG device together;
where bonding is performed such that
the composite VBG device performs optical stretching along a first optical travel direction and optical compression along a second optical travel direction through the composite VBG device; and
a first portion of an incoming optical pulse passes through the first VBG, a second portion of an incoming optical pulse passes through the second VBG, and
the first and second portions exit the composite VBG together as an outgoing stretched or compressed optical pulse;
providing a first optical assembly on a stretcher side of a beam path into the composite VBG; and
providing a second optical assembly on a compressor side of a beam path into the composite VBG′;
where the second optical assembly is configured such that a diameter, collimation and rotational orientation of a beam entering the compressor side of the composite VBG is the same as the diameter and rotational orientation of a beam exiting the stretcher side of the composite VBG.
